(19) United States
(12) Patent Application Publication
(10) Pub. No.: US 2010/0212444 A1
(43) Pub. Date: Aug. 26, 2010

(54) Conjugate roller drive

(76) Inventor: Thomas David Smith, York, PA (US)

Correspondence Address: Thomas D. Smith, 91 Penny Lane, York, PA, 17402, US

(21) Appl. No.: 12/656,947

(22) Filed: Feb. 22, 2010

Related U.S. Application Data
(60) Provisional application No. 61/208,160, filed on Feb. 23, 2009.

(51) Int. Cl. F16H 1/16; F16H 55/17; F16H 55/22

(52) U.S. Cl. 74/425; 74/465

(57) ABSTRACT

This invention provides improvements to worm drives for mechanical power transmission and roller wheels and the worm screws for use in such drives. The principal innovation is utilizing conjugate mesh between the worm screw and the roller wheel by shaping both the surfaces of the threads of the worm screw and the driven surfaces of the roller tips so that they become conjugate surfaces that accomplish the most efficient energy transfer.

Previous worm drive approaches have emphasized conforming shapes for the roller tips and the worm screw as well as certain other techniques in an attempt to compensate certain inherent limitations to energy transfer between driving and driven surfaces. This has caused greater energy losses in the gearing mechanism with corresponding decreased power transfer efficiency. The use of conjugate shapes for the roller tips and the driving worm gear surface represents a significant improvement to the concept.

### BACKGROUND OF THE INVENTION

This application claims priority to U.S. Provisional Patent Application No. 61/208,160 entitled CONJUGATE ROLLER DRIVE filed Feb. 23, 2009 which is incorporated herein by reference for all purposes.

This invention provides improvements to worm drives for mechanical power transmission and roller wheels and the worm screws for use in such drives. The principal innovation is utilizing conjugate mesh between the worm screw and the roller wheel by shaping both the driving surfaces of the threads of the worm screw and the driven surfaces of the roller tips so that they become conjugate surfaces that accomplish the most efficient energy transfer. This provides improved power transfer efficiency with respect to that accomplished using conventional worm drives.

Previous worm drive approaches have emphasized conforming shapes for the roller tips and the worm screw as well as certain other techniques in an attempt to compensate certain inherent limitations to energy transfer between driving and driven surfaces. This has caused greater energy losses in the gearing mechanism with corresponding decreased power transfer efficiency. The use of conjugate shapes for the roller tips and the driving worm gear surface represents a significant improvement to the concept.

Worm gear drives that have been in use for many decades include a worm screw engaging a gear wheel that has fixed teeth that are shaped to conform to the threads of the worm screw. As the worm screw rotates, its threads engage the teeth on the gear wheel and drive said gear wheel in rotation. With this mechanism, there is sliding motion between the surfaces of the worm gear threads and the surfaces of the teeth on the gear wheel hence considerable friction resulting in considerable heat generation and corresponding mechanical power loss.

As disclosed in U.S. Pat. No. 626,515, issued Jun. 6, 1899, these frictional losses can be reduced substantially if the wheel is provided with rollers in contact with worm gear threads rather than fixed teeth. As taught by the 626,515 patent, the rollers may be arranged so that the axis of each roller extends substantially in a radial direction with respect to the axis of the roller wheel, and each roller may be mounted to the roller wheel by means of anti-friction bearings. Each roller has a tip projecting outwardly from the body of the wheel. As the worm screw rotates, the worm screw thread surfaces engage the tips of successive rollers and drive the wheel in rotation. Each roller is free to rotate about its own axis relative to the roller wheel, substantially decreasing sliding friction between the roller tips and the worm screw thread surfaces.

U.S. Pat. No. 4,833,934 teaches a conformal worm drive concept comprising a roller wheel and a worm screw having an envelope surface in an “hour glass shape” that conforms to a portion of the outside surface of the roller wheel. Here, the axial cross section of the worm screw threads and the roller tips have a “frustroconical” shape. The mesh between the threads of the worm screw and the tips of the rollers is optimum only for a brief portion of the drive cycle of each tip.

The principal contribution of U.S. Pat. No. 4,833,934 was the spring loading of the rollers by mounting them in thrust bearings to allow limited axial outward/inward translation of roller tips along each individual roller axis during the drive cycle in order to increase the contact time between the worm screw threads and the tips of the rollers during the drive cycle. In practice, the axial motion by spring action was effective at relatively slow rotational speeds. At high speeds, however, said axial motion became incomplete because the cycle time of each roller became shortened such that there was insufficient time for the spring action to force the roller to recover in an outward direction to the optimum outboard position before contact with the worm gear drive surface at the beginning of the next cycle. The present invention eliminates the need for spring loaded rollers by maintaining optimum contact throughout the entire drive cycle regardless of the rotational speed of the roller wheel.

U.S. Pat. No. 4,685,346 provides for a wheel with two sets of angularly arranged rollers rather than a single set of rollers arranged in a radial direction. The angularly arranged rollers are disposed so that the rollers of one set project in one direction along the axis of the roller wheel, whereas the rollers of the other set project in the opposite direction along the axis of the roller wheel. The rollers of the two sets are staggered, so that each roller of one set is disposed between rollers of the other set. This arrangement substantially increases the power transmission capacity that can be accomplished with a roller wheel of given diameter. The present invention can provide the conjugate drive improvement to a roller wheel having said angularly arranged staggered rollers.

U.S. Pat. No. 4,833,934 and U.S. Pat. No. 4,685,346 formed the basis for a product known as “Roller Gear™” that was marked by a company of the same name until they went out of business. The present invention represents an improvement to that product.

### SUMMARY OF THE INVENTION

The present invention provides for optimum mesh between the driving worm gear and the tips of the rollers of the driven roller wheel in a worm drive system over the full range of drive conditions. This optimum mesh is accomplished by making the driven surface of the tip of the roller in the wheel in the shape of a figure of revolution of an involute curve about the roller axis and by forming the surface of the worm drive according to a corresponding conjugate involute curve such that the worm screw axial cross section is an involute curve that is conjugate to the surface of the roller.

The involute drive has the invaluable ability of providing conjugate action even when the worm drive configuration is less than optimum, as is typical in practice. Involute surfaces allow optimum drive even when the center distance between gears is varied either intentionally, or unintentionally due to wear, manufacturing tolerances or other variations from an optimum configuration. Therefore, with this invention there is always an optimum mesh between the worm drive and the roller tips for the worm drive configuration. Worm screw and roller tip combinations employing any other conjugate shapes such as the epicycloidal shape or hypocycloidal shape are included within the spirit of this invention although the involute shape provides the most efficient design concept.

Involute Curve-Graphical Description

FIG. 1 provides a demonstration of graphical construction of an involute curve of a circle and shows the trigonometric equations that describe the curve mathematically. Graphically, this construction is described as unwinding a taut string as initially wrapped around a circular disc and tracing the locus of points intersected by the end of the string as the unwinding proceeds.

As demonstrated here, the first point of the involute curve is identical to the point at the end of the string before the unwinding process begins. FIGS. 1(a) through 1(c) show three subsequent stages of this graphical construction. An early stage of the graphical construction is illustrated by FIG. 1(a). An intermediate stage is illustrated by FIG. 1(b) and a near final stage is illustrated by FIG. 1(c). The basic involute curve of interest for this invention is completed when the tangent point (Xₜₙ, Yₜₙ) on the disc of string (Sₙ) reaches a point 90 degrees around the disc with respect to the initial point of the involute curve.

Involute Roller Tip-Graphical Construction

Graphical construction of an involute roller tip surface is illustrated by first constructing a line tangent to the disc at the initial point of the involute curve in the above graphical involute curve construction where said line is coplanar to both the disc and the involute curve. The next step is to separate the axis and involute curve lines from the disc as a combined assembly and then define the tangent line as an axis of rotation. The involute roller tip is then formed by rotating the involute curve about the axis of rotation by 360 degrees causing the involute curve to trace a three dimensional involute surface of revolution as is illustrated in FIG. 2(b). Said involute surface of revolution is the form of the involute roller tip of the preferred embodiment of the roller tip of this invention.

Involute Worm Screw-Graphical Construction

FIG. 3 illustrates a graphical construction of a worm gear with an involute thread that is conjugate to the roller tip illustrated in FIG. 2(b). Graphical construction proceeds by first postulating a cylindrical shaft with a helical line drawn around its outer surface. The base of the involute roller tip as described above is then attached to the helical line near one end, of the shaft with the axis of rotation of said involute cross section roller tip section passing through the helical line and intersecting the axis of the shaft at a 90 degree angle. The graphical outline of the thread of the involute worm gear is then formed by moving said involute cross section roller tip along the helical line of the stationary shaft in a manner such that the axis of the involute cross section follows the helical line with said axis always perpendicular to the shaft's rotational axis and such that the base of the involute cross section roller tip is always in contact with the surface of the shaft. The the solid object thus formed by surface of the involute cross section roller tip when following the helical line along the shaft in this manner forms a worm screw with a thread surface that is conjugate to said involute roller tip by having an identical involute cross section as an axial cross section of said involute cross section roller tip.

In a similar manner, a conjugate drive roller gear assembly can be constructed for conjugate epicycloidal , hypocycloidal or other conjugate shapes that would provide a conjugate mesh between a worm drive and a roller wheel.

These and other objects, features and advantages of the present invention will be more readily apparent from the detailed description of the preferred embodiments set forth here below, taken in conjunction with the accompanying drawings.

### SUMMARY OF THE INVENTION

The present invention can provide these improvements in a roller wheel having angularly arranged rollers or in a roller wheel having radially disposed rollers.

### BRIEF DESCRIPTION OF THE DRAWINGS

FIG. 1 is a fragmentary, schematic graphical illustration of the construction of an involute curve.

FIG. 2 is a fragmentary, schematic graphical illustration of the construction of an involute shaped roller tip.

FIG. 3 is a fragmentary, schematic graphical illustration of the construction of a worm gear with involute shaped threads.

FIG. 4 is a fragmentary, schematic sectional view illustrating the engagement of the involute shaped roller tips by an involute worm drive according to one embodiment of the present invention.

FIG. 5 is a fragmentary, schematic, sectional view of a worm drive according to one embodiment of the present invention.

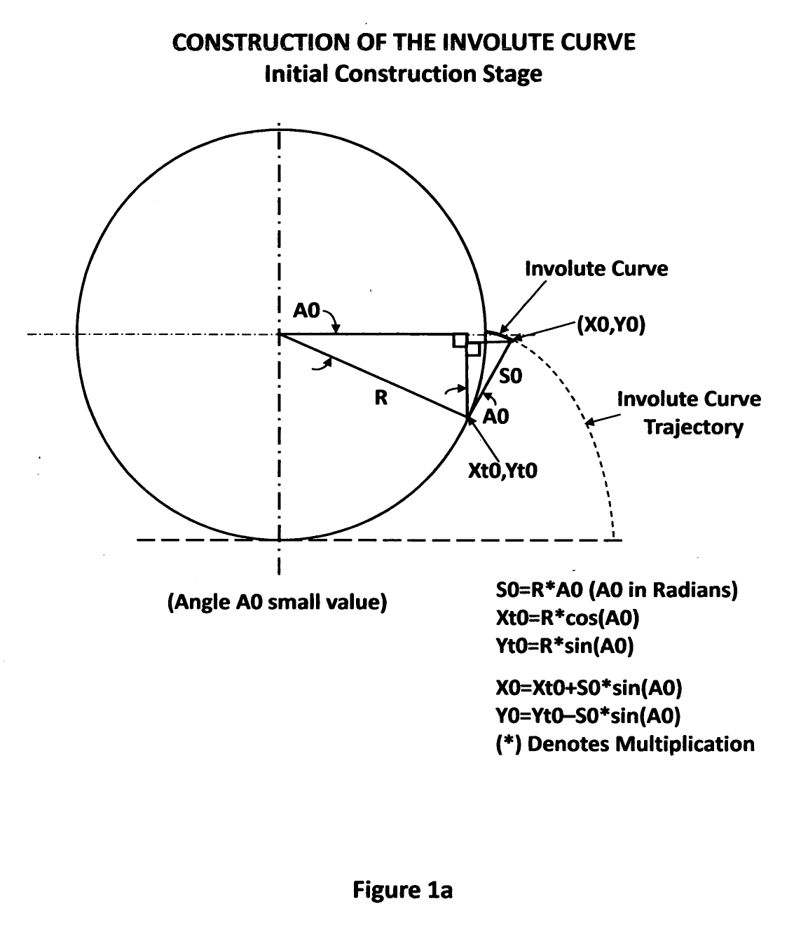

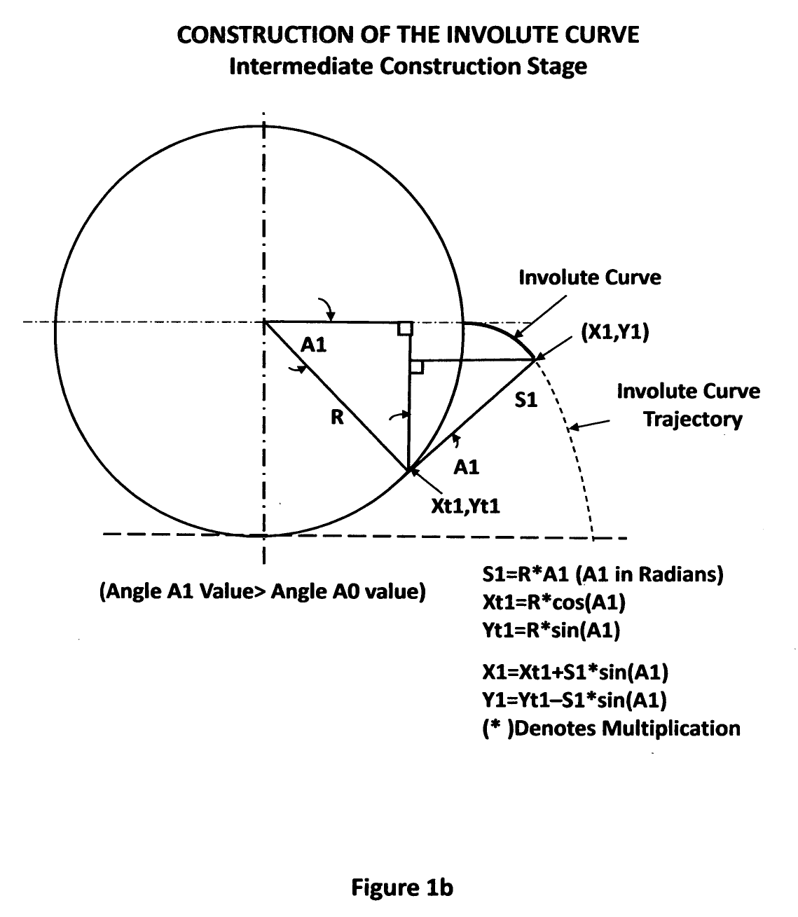

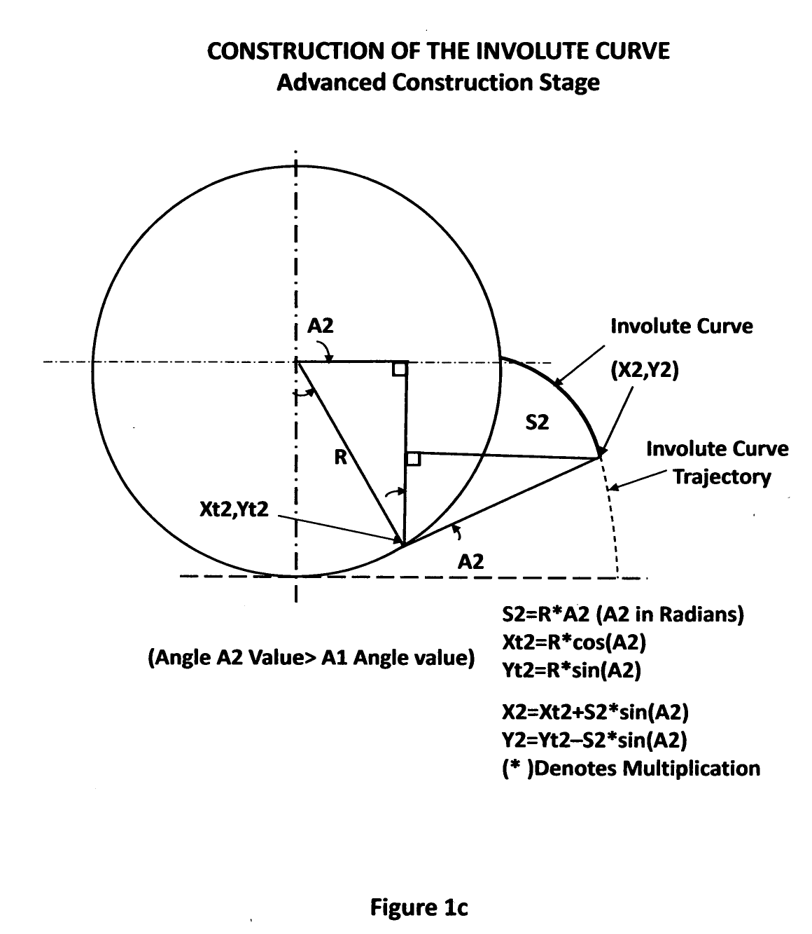

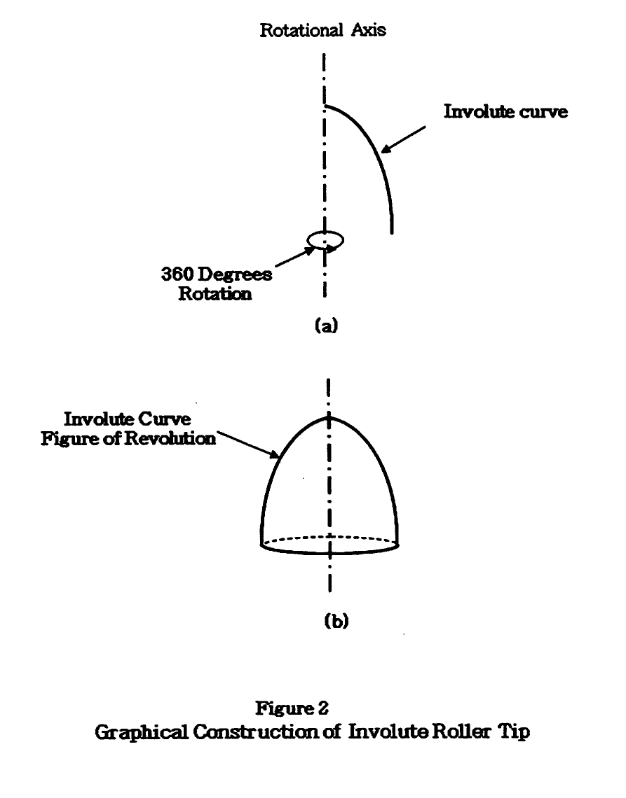

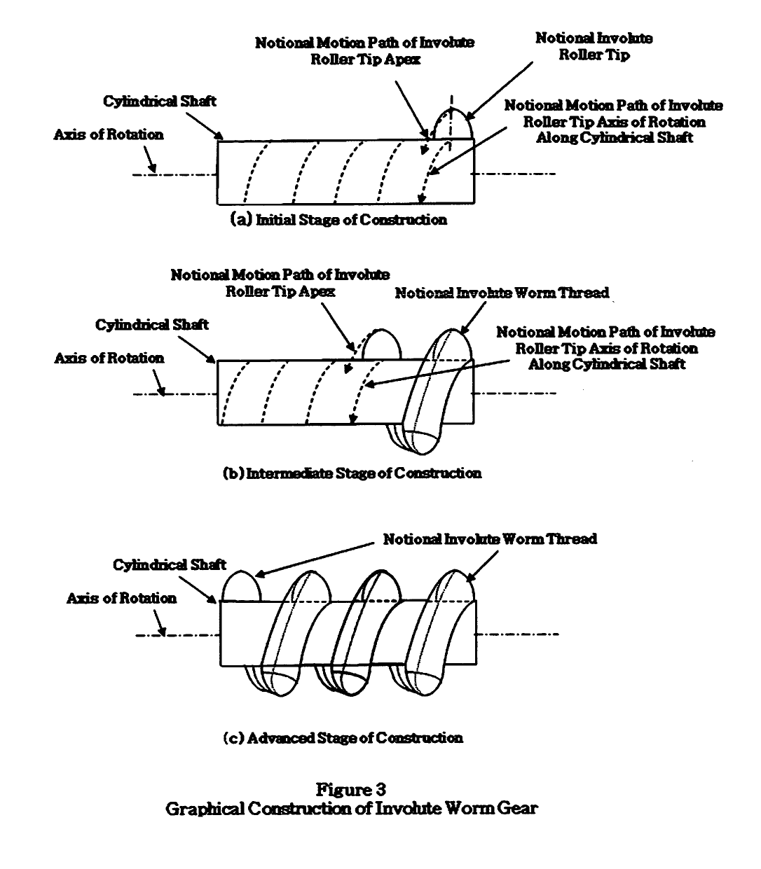

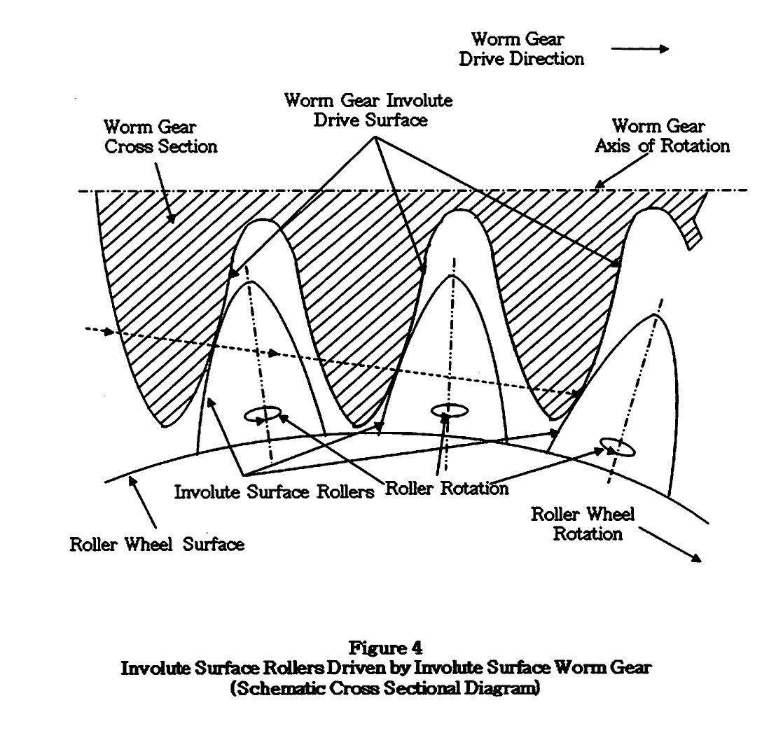

Applicant realizes that a number of other conjugate worm drive systems that would produce substantially similar or even superior results can and should be used and would not depart from the spirit and scope of the invention and the inclusion and/or use of these previously described/incorporated conjugate worm drive embodiments in Applicant's invention should not be construed so as to limit the nature of the described invention or in any manner affect the scope of the subjoined claims. An example would be a design using two worm screws simultaneously engaging a single roller wheel. Another example would be a design using a single worm screw with two independent threads engaging two independent sets of rollers on a single roller wheel

### DETAILED DESCRIPTION OF THE PREFERRED EMBODIMENT

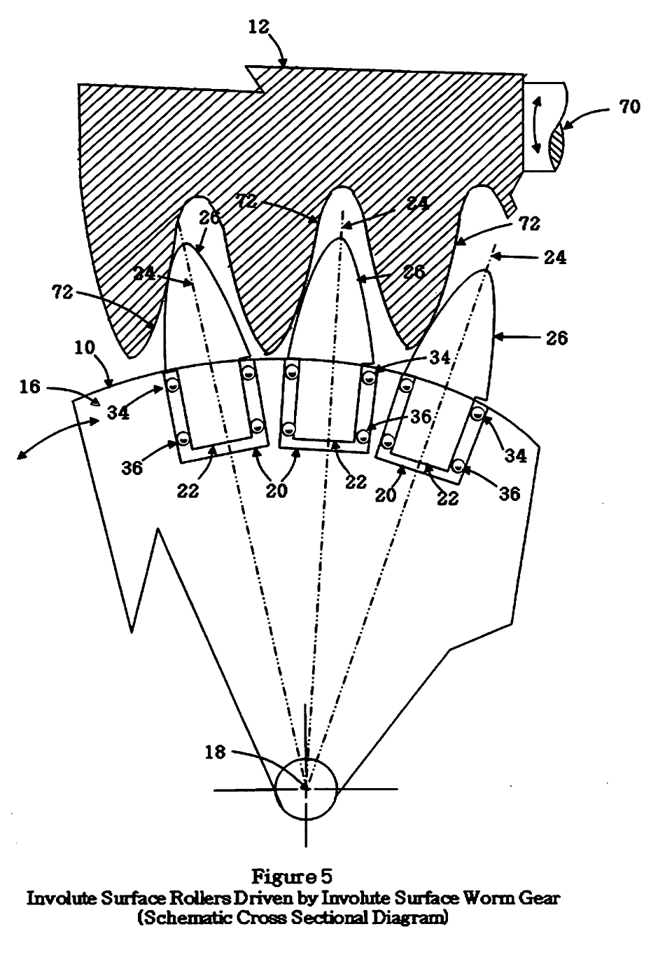

A worm drive according to one embodiment of the present invention, depicted in FIG. 5 includes a roller wheel 10 and a worm screw 12. The roller wheel 10 includes a body 16 defining a body axis 18. The body is mounted for rotation about body axis 18 by appropriate bearings (not shown) or equivalent means. A plurality of bores 20, are formed in body 16, the bores being disposed in a common plane and extending substantially radially with respect to body axis 18, the bores being spaced at equal intervals about the periphery of the body 16.

A plurality of rollers 22 are carried on body 16. Each roller tip 26 is in the form of a figure of revolution of an involute curve about a roller axis 24. The rollers 22 are received in bores 20 so that the roller axes 24 extend radially with respect to body axis 18. Directions and locations along each roller axis 24 are specified herein as either “inboard” or “outboard”. As used herein, the term “inboard” means the direction along the roller axis 24 towards body axis 18, whereas the direction “outboard” is the opposite direction, away from the body axis 18. Each roller 22 has, at its outboard end, a tip 26 defining a tip surface which is a surface of revolution of an involute curve about roller axis 24. Each roller 22 is supported on body 16 by an outboard antifriction bearing 34 and an inboard antifriction bearing 36 associated with the roller.

The roller wheel 10 is in mesh with the worm screw 12. The worm screw is generally a cylindrical shape defined by a surface of revolution about a screw axis 70 although other shapes could be used. The screw has helical threads 72 on its exterior surface shaped to have an involute drive surface that is conjugate to the driven surfaces of all of the roller tips 26. The tips 26 of rollers 22 are meshed in these threads 72. The screw is supported for rotation about screw axis 70 by bearings (not shown) or equivalent means. Upon rotation of the screw about the screw axis 70, engagement of threads 72 with the rollers forces the roller wheel to rotate about the body axis 18. As the screw 12 rotates, forces are transmitted between the screw and the roller wheel body via the roller tips.

The foregoing description of the preferred embodiment should be taken by way of illustration rather than by way of limitation of the present invention as defined by the claims. It will be understood that the embodiments described herein are merely exemplary and that a person skilled in the art may make many variations and modifications without departing from the spirit and scope of the invention. All such modifications and variations are intended to be included within the scope of the invention as defined in the appended claims.

I claim:

1. A roller wheel for use in a worm drive system comprising:
(a) a body defining a body axis;
(b) a roller wheel mounted for rotation about a roller wheel axis of rotation;
(c) a plurality of rollers carried on said roller wheel, each roller having a roller axis extending in inboard and outboard directions towards and away from said body axis, respectively; each roller having a tip at its outboard end that has the shape of a figure of revolution about said roller axis;
(d) an outboard anti-friction bearing and an inboard anti-friction bearing associated with each of said rollers, said outboard bearings being disposed inboard of said tips, said inboard bearings being disposed inboard of said outboard bearings, said inboard and outboard bearings supporting said rollers on said body so that each said roller is rotatable about its roller axis relative to said body;
(e) a worm screw having a screw thread shaped to be in optimum conjugate mesh engagement with the tips of said rollers on said roller wheel with said worm screw thread surface having optimum conjugate mesh to the surfaces of said rollers upon simultaneous rotation of said roller wheel and said worm screw.

2. A roller wheel according to claim 1 in which said roller axes extend in a common plane perpendicular to said body axis.

3. A roller wheel according to claim 2, in which said roller axes extend substantially radially with respect to said body axis.

4. A worm drive system according to claim 1 where the surface of each of said roller tips has the shape of a figure of revolution of an involute curve about their respective axes and said worm screw thread surface as seen in axial cross section of said worm screw has the shape of an involute curve and has optimum conjugate mesh to all of said surfaces of said roller tips that it engages sequentially upon rotation of said worm screw and said roller wheel.

5. A worm drive system according to claim 1 where the surface of each of said roller tips has the shape of a figure of revolution of a hypocycloidal curve about their respective axes and said worm screw thread surface as seen in axial cross section of said worm screw has the shape of an hypocycloidal curve and has optimum conjugate mesh to all of said surfaces of said roller tips that it engages sequentially upon rotation of said worm screw and said roller wheel.

6. A worm drive system according to claim 1 where the surface of each of said roller tips has the shape of a figure of revolution of an epicycloidal curve about their respective axes and said worm screw thread surface as seen in axial cross section of said worm screw has the shape of an epicycloidal curve and has optimum conjugate mesh to all of said surfaces of said roller tips that it engages sequentially upon rotation of said worm screw and said roller wheel.

7. A worm drive system according to claim 1 wherein said roller wheel defines a medial plane normal to said roller wheel axis of rotation and the roller axes of said first and second sets of rollers are disposed at oppositely directed angles relative to said medial plane so that the roller axes of said first and said second sets slope toward said roller wheel axis of rotation on opposite sides of said medial plane.

8. A worm drive system according to claim 7, wherein said rollers of said first set of rollers are staggered in relationship to said rollers of said second set of rollers.

9. A worm drive system according to claim 7, wherein said rollers of said first set of rollers lie on one side of said medial plane and said rollers of said second set of rollers lie on an opposite side of said medial plane.

10. A worm drive system according to claim 7, wherein said anti-friction bearings associated with said rollers, of said first set of rollers are disposed on one side of said medial plane and the bearings associated with the rollers of said second set are disposed on the opposite side of said medial plane.

11. A worm drive system according to claim 7 where the surface of each of said roller tips has the shape of a figure of revolution of an involute curve about their respective axes and said worm screw thread surface as seen in axial cross section of said worm screw has the shape of an involute curve and has optimum conjugate mesh to all of said surfaces of said roller tips that it engages sequentially upon rotation of said worm screw and said roller wheel.

12. A worm drive system according to claim 7 where the surface of each of said roller tips has the shape of a figure of revolution of a hypocycloidal curve about their respective axes and said worm screw thread surface as seen in axial cross section of said worm screw has the shape of an hypocycloidal curve and has optimum conjugate mesh to all of said surfaces of said roller tips that it engages sequentially upon rotation of said worm screw and said roller wheel.

13. A worm drive system according to claim 7 where the surface of each of said roller tips has the shape of a figure of revolution of an epicycloidal curve about their respective axes and said worm screw thread surface as seen in axial cross section of said worm screw has the shape of an epicycloidal curve and has optimum conjugate mesh to all of said surfaces of said roller tips that it engages sequentially upon rotation of said worm screw and said roller wheel.

14. A worm drive system, comprising:
(a) A body defining a body axis;
(b) A roller wheel mounted for rotation about a roller wheel axis of rotation;
(f) a plurality of rollers carried on said body, each roller having a roller axis extending in inboard and outboard directions towards and away from said body axis, respectively, each roller having a tip at its outboard end; and means for mounting each of said rollers on said roller wheel for rotation about its roller axis relative to said roller wheel, the roller axes of said rollers of said first and second sets being disposed in different orientations relative to said roller wheel axis of rotation so that said roller axes of said rollers of said first set extend toward one point on said roller wheel axis of rotation and said roller axes of said rollers of said second set extend toward another, different point on said roller wheel axis of rotation; and
(d) first and second sets of rollers, each of said rollers having a roller axis, and mounting means for each of said rollers on said roller wheel for rotation about its roller axis relative to said roller wheel, the roller axes of said rollers of said first and second sets being disposed in different orientations relative to said roller wheel axis of rotation so that said roller axes of said rollers of said first set extend toward one point on said roller wheel axis of rotation and said roller axes of said rollers of said second set extend toward another, different point on said roller wheel axis of rotation; and
(e) a first worm screw having a first screw thread shaped to be in optimum conjugate mesh engagement with said first set of rollers on said roller wheel and a second screw thread shaped to be in optimum conjugate mesh engagement with said second set of rollers on said roller wheel, said second screw thread of said first worm screw being separate and distinct from said first screw thread of said first worm screw, said second screw thread having a configuration different from said screw thread, said first screw thread having surfaces matching said surfaces generated by said rollers of said first set upon simultaneous rotation of said roller wheel and said first worm screw, the second screw thread having surfaces matching the surfaces generated by said rollers of said second set upon simultaneous rotation of said roller wheel and said first worm screw.

15. A worm drive system according to claim 14 where the surfaces of said roller tips are in the shape of a figure of revolution of an involute curve and any axial cross section of said worm screw thread surface has the shape of an involute curve with optimum conjugate mesh to all of said roller tip surfaces.

16. A worm drive system according to claim 14 where the surfaces of said roller tips are in the shape of a figure of revolution of an epicycloidal curve and any axial cross section of said worm screw thread surface has the shape of an epicycloidal curve with optimum conjugate mesh to all of said surfaces of said roller tips.

17. A worm drive system according to claim 14 where said surfaces of said roller tips are in the shape of a figure of revolution of a hypocycloidal curve and any axial cross section of said worm screw thread surface is a hypocycloidal curve with optimum conjugate mesh to said surfaces of said roller tips .

18. A drive system according to claim 1 comprising:
First and second worm screws, each having screw threads shaped to be in optimum conjugate mesh engagement with the tips of said rollers on said roller wheel with said worm screw thread surface having optimum conjugate mesh to the surfaces of said rollers upon simultaneous rotation of said roller wheel and said worm screw.

19. A drive system according to claim 7 comprising:
First and second worm screws, each having screw threads shaped to be in optimum conjugate mesh engagement with the tips of said rollers on said roller wheel with said worm screw thread surface having optimum conjugate mesh to the surfaces of said rollers upon simultaneous rotation of said roller wheel and said worm screw.

20. A drive system according to claim 14 comprising:
First and second worm screws, each having screw threads shaped to be in optimum conjugate mesh engagement with the tips of said rollers on said roller wheel with said worm screw thread surface having optimum conjugate mesh to the surfaces of said rollers upon simultaneous rotation of said roller wheel and said worm screw.
